(19) United States
(12) Patent Application Publication
(10) Pub. No.: US 2008/0030625 A1
(43) Pub. Date: Feb. 7, 2008

(54) 3 Band Tv-Rf Input Circuit

(75) Inventor: Kam Choon Kwong, Singapore (SG)

Correspondence Address: NXP, B.V.;NXP INTELLECTUAL PROPERTY DEPARTMENT, M/S41-SJ, 1109 MCKAY DRIVE, SAN JOSE, CA, 95131, US

(73) Assignee: KONINKLIJKE PHILIPS ELECTRONICS N.V., Eindhoven (NL)

(21) Appl. No.: 11/596,828

(22) PCT Filed: May 13, 2005
(86) PCT No.: PCT/IB05/51576

§ 371 Date: Nov. 16, 2006

(30) Foreign Application Priority Data
May 19, 2004 (EP) 04300296.3

(51) Int. Cl. H04N 5/50

(52) U.S. Cl. 348/731; 348/E05.097

(57) ABSTRACT

The present invention relates to a TV-tuner input circuit. The input circuit comprises an RF coupling device via which RF an aerial input (RFI) is coupled to first (330), second (340) and third (350) parallel tunable RF resonant circuits for a parallel selection of a desired frequency in first, second and third TV frequency bands substantially succeeding one another in frequency. The first RF resonant circuit comprises a first RF resonance circuit inductance (L6) and wherein said RF coupling device having a first series inductance (L3) that can be magnetically coupled with the first RF resonance circuit inductance (L6) enabled by a switched capacitor (Cu) using a band-high switch (Vhigh). In one embodiment the third RF resonant circuit includes a tuned ½ RF trap (320). In another embodiment the RF coupling device further comprises an FM trap (380), and wherein the FM trap (380) can be bypassed by switching a capacitor (Cinf1) by using an FM-switch (Vfm).

### FIELD OF THE INVENTION

The invention relates to a TV-RF input circuit provided with an RF coupling device via which an aerial input is coupled to first, second and third parallel tunable RF resonant circuits for a parallel selection of a desired frequency in first, second and third TV frequency bands substantially succeeding one another in frequency, said RF coupling device having a much improved noise figure.

The present invention is particularly relevant for a TV-tuner and TV-Front-end that brings improvements, e.g., to watching broadcasted content on a TV, or, to watching analogue and digitally broadcasted content on a matrix display that is, e.g., part of a mobile gadget etc.

### BACKGROUND OF THE INVENTION

In a known TV tuner, the first, second and third RF resonant circuits are arranged in first, second and third signal paths, respectively, which are mutually parallel arranged between the coupling device, on the one hand, and a TV-IF output of the tuner on the other hand. The entire TV reception signal of the aerial is applied in a broad band via the RF coupling device to each of the RF resonant circuits. The RF resonant circuits are parallel tunable from one common tuning voltage to TV frequency bands succeeding one another substantially contiguously. With the aid of the first, second and third RF resonant circuits, a TV channel is selected in TV frequency bands of approximately 45 MHz to 160 MHz, 160 MHz to 470 MHz and 470 MHz to 860 MHz, respectively. Each signal path comprises an amplifier stage arranged downstream of the RF resonant circuit, which stage also functions as a band switch, and is followed by a further tunable TV channel filter and a mixer stage to which an oscillator mixing signal is applied from a tuning oscillator. One of the signal paths is activated by means of a switching signal. That is to say, the TV channel selected in the RF resonant circuit preceding the band switch in one of the signal paths is switched through via this band switch for a further selection and conversion into a TV-IF signal.

In a prior art tuner described in U.S. Pat. No. 4,851,796, a TV-RF input circuit is characterized in that second and third series inductances of mutually equal order of magnitude are arranged in the first and second inductive shunt branches, respectively, said second and third series inductances being coupled at one end to either side of a capacitor arranged in the capacitive series branch and at the other end to second and third RF resonant circuits, respectively, said first series inductance being at least several times larger than each of the two other series inductances. In an embodiment of this prior art tuner, in which the first, second and third TV frequency bands are substantially between 45 and 160 MHz, 160 and 470 MHz, and 470 and 860 MHz, the TV-RF input circuit is characterized in that the first, second and third series inductances at least partly compensate impedance variations of the RF resonant circuits respectively coupled thereto for tuning variations within the first, second and third TV frequency bands, respectively, and match these impedances with the aerial impedance.

Since the 1990's the TV-RF input circuit of U.S. Pat. No. 4,851,796 has been used for terrestrial analog receivers for TV. A slightly modified concept of the TV-RF input circuit of U.S. Pat. No. 4,851,796 is still in use and now extended for digital terrestrial. This input circuit is still superior to switched 2 band concepts and is the basis for high performance analog/digital tuners for large screen Flat TVs (PDP, LCD, projection). However and in particular for off-air and mobile applications both digital and analog, many issues have to be addressed.

For immunity, digital TV transmitters are from the onset much reduced in transmitted power compared to the existing analog ones. These transmitters and, in addition to it, the existing citizen's band and traditional FM radio will still be in use until 2010 or beyond. These transmitters are expected to present problems for the broadband antenna, be it mobile or fixed until it is finally turned off, if ever.

The TV-RF input circuit of U.S. Pat. No. 4,851,796 has the following drawbacks: no CB trap in any band, no FM trap, a high noise figure for UHF (requirement for FNAC are S/N 47 dB typical) and in low band (in particular at the edges) due to large coupling/matching coils used, large tuning/matching coils make miniaturization difficult (apart from this, the coil must be mechanically secured to prevent micro-phony and it also has a self resonance that causes problems in high band) and surge protection not sufficiently high.

### SUMMARY OF THE INVENTION

It is, accordingly, an object of the present invention to provide a tuner input circuitry for receiving RF signals with a low noise figure.

It is another object of the invention to provide a tuner input circuitry for receiving RF signals that comprises at least one of a band-high switch and a switch-able FM-trap. trap. Both provisions will improve rejection of unwanted signals while maintaining a low noise figure.

It is yet another object of the invention to provide a tuner module with a reduced size but superior noise figure as a result of circuitry applied that allows usage of smaller components.

In one embodiment, a tuned ½ RF trap circuit is applied in the tuner input circuitry.

In another embodiment, a band high switch and a switch-able FM trap circuit is applied in the tuner input circuitry.

These and other aspects of the invention will be apparent from and will be elucidated with reference to the embodiments described hereinafter.

### BRIEF DESCRIPTION OF THE DRAWINGS

The present invention will now be described in more detail, by way of example, with reference to the accompanying drawings, wherein:

FIG. 1 shows a prior art RF input circuit;

FIG. 2 shows another prior art RF input circuit;

FIG. 3 shows an embodiment of an RF input circuit in accordance with the present invention; and

FIG. 4 shows an example of a frequency versus amplitude diagram of a tuned ½ RF trap.

Throughout the drawings, the same reference numeral refers to the same element, or an element that performs substantially the same function.

### DETAILED DESCRIPTION OF THE INVENTION

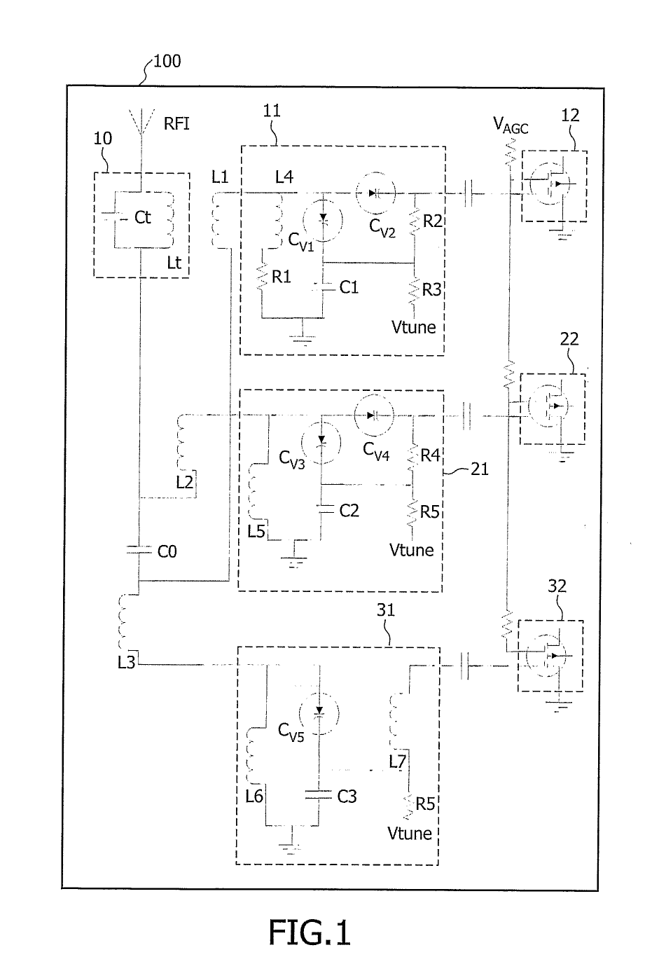

FIG. 1 shows a prior art RF input circuit 100. The (TV−) RF input circuit 100 comprises an IF trap filter 10 for suppressing signals at the TV image and sound intermediate frequency, via which the RF aerial input RFI is coupled to an input of a high-pass .pi.-section C, L2, L3. The .pi.-section C, L2, L3 comprises in a .pi.-configuration a capacitor C arranged in a capacitive series branch one end of which is connected to the input end of the .pi.-section and is coupled to a first inductive shunt branch and the other end of which is connected to the output end of the .pi.-section and is coupled to a second inductive shunt branch. The output of the .pi.-section is coupled to a first RF resonant circuit 11 via a coupling coil L1 functioning as a so-called first series inductance. The first and second inductive shunt branches are constituted by coupling coils L2 and L3, respectively functioning as so-called second and third series inductances. These first, second and third signal path comprise the above-mentioned first RF resonant circuit 11, and second and third RF resonant circuits 21 and 31, each being connected to the transformation coils L1, L2 and L3, respectively, and which are simultaneously parallel tunable, from a tuning voltage Vtune, which is common for all circuits, to first, second and third TV frequency bands I, II and III of 45-160 MHz (band-low), 160-470 MHz (band-mid) and 470-870 MHz (band-high), respectively. The RF resonant circuits 11, 21 and 31 are coupled via coupling capacitors to first gate inputs of dual gate field effect transistors FET 12, 22 and 32, respectively. The Low band is tuned by varicap Cv1 and coil L4 and coil L1 is the matching coil (typically 300-400 nH) Due to its size, coil L1 creates a self resonance in high band and must be secured (glued) to prevent microphony effects.

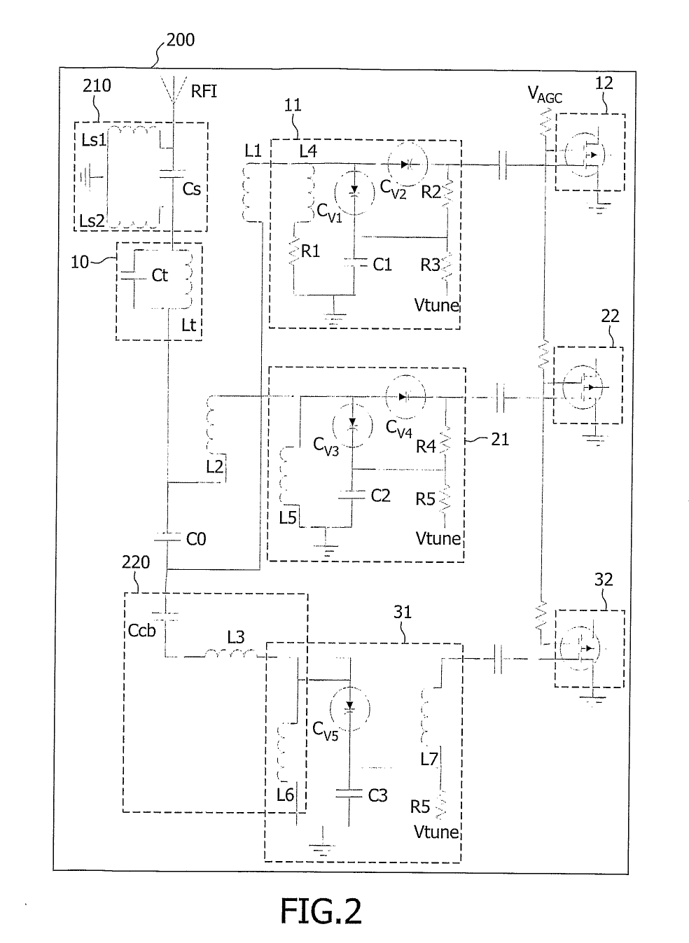

FIG. 2 shows another prior art (TV) RF-input circuit 200. Two differences compared to FIG. 1 can be observed: coil Ls1, coil Ls2 and capacitor Cs form a high pass with DC ground 210 (a pi² arm) to improve surge protection and capacitor Ccb is added to form a CB trap 220 in the third TV-band (in UHF at ˜27 MHz with coil L3 and coil L6).

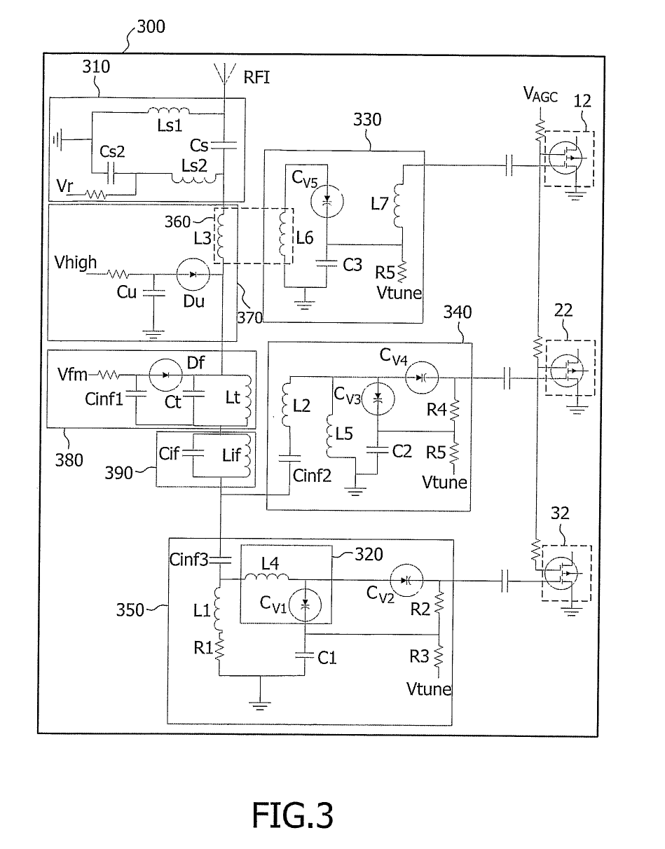

FIG. 3 shows an RF input circuit 300 in accordance with the present invention and that is very suitable for TV-signal reception. RF input circuit 300 comprises a first RF resonant circuit 330 (typically for band-high 470˜870 MHz), a second RF resonant circuit 340 (typically for band-mid 160˜470 MHz) and a third RF resonant circuit 350 (typically for band-low 45˜160 MHz).

An RF signal can be inputted or received by the RF input circuit 300 at RFI. RF coupling circuit 310 comprises coil Ls1, coil Ls2, capacitor Cs2 and capacitor Cs. Coil Ls2 and capacitor Cs2 form a CB trap (Citizen's Band trap). A typical value for coil Ls2 is 180 nH and for capacitor Cs2 180 pF and a typical depth of the CB trap is >50 dB @27 MHz. IF trap circuit 390 comprises coil Lif and capacitor Cif that form an IF trap. An IF trap filters out tuner or front-end Intermediate Frequency (IF) signals (typically around 33˜39 MHZ for PAL and for NTSC ˜45.75 and for Japan ˜58.75) that may inadvertently be received through RFI. A typical value for coil Lif is 145 nH and capacitor Cif is 120 pF, a typical trap depth is >20 dB. FM-trap circuit 380 comprises coil Lt and capacitor Ct that form an FM-trap. The capacitors Cinf1, Cinf2 and Cinf 3 act as DC blocking capacitors for the DC signals injected by Vr, Vhigh and Vfm. Capacitor Cinf2 can be configured as another trap as well for low band. In fact it can be interchanged with coil Ls2 and capacitor Cs2 to form a CB trap or in addition to. In other words, capacitor Cinf2 and (coil L2 plus coil L5) can be configures as a CB trap and Ls2 and Cs2 can be configures as either another CB trap or an IF trap. Input voltage Vr can be applied and diode Du and diode Df will reverse their bias. Vr is typically set at approximately 0.5 Vcc (Vcc is the supply voltage) in order to avoid non-linearities. A person skilled in the art understands that Vr can be injected at several places in RF input circuit 300, e.g., below capacitor Cif or coil Lif.

A floating diode is non linear and therefore acts as a mixer. This can be detrimental when connected to a fully loaded cable. Signals as high as 125 mV rms can be expected and therefore the reverse bias has to be present and sufficiently enough to prevent the diode going anywhere near the 0.7 V threshold. This could have been the case for Diode Du when Vhigh is set to low and/or for Diode Df when Vfm is set to low.

Specifics that are most relevant for band-high: band-high switch circuit 370 comprises capacitor Cu and diode Du. Capacitor Cu acts as an AC ground for diode Du. A band-high switch (using input Vhigh) can switch capacitor Cu to ground. When the band-high switch is set to ON (typically Vhigh is set to Vcc), diode Du conducts and capacitor Cu will tune coil L3 to below the lowest frequency. Coil L3 hence becomes effectively an inductor coupling energy from coil L3 to coil L6. Additionally, circuitry behind band-high switch circuit 370 (e.g., circuit 380, 390, 340 and 350) will become essentially invisible to band-high. This is advantageous for these circuits as their design (choice of components) becomes easier. This is because (a part of) these circuits (in particular third RF resonant circuit 350) could otherwise have caused certain unwanted traps for band-high. In band high coupling circuitry 360 comprises coil L3 and coil L6 that are magnetically coupled for band high. In another embodiment (not explicitly shown) coil L3 is placed behind the IF trap (looking from RFI input side) and a person skilled in the art will understand that such a configuration will also work since capacitor Ct and capacitor Cif are relatively large (>100 pF). When the band-high switch is set to OFF (typically 0.2 V) almost no coupling between coil L3 and L6 will take place and the tuner will be tuned to either band-mid or band-low. Vice versa this means that the circuitry behind band-high switch circuit 370 (e.g., circuit 380, 390, 340 and 350) will not see first RF resonant circuit 330. This is advantageous for first RF resonant circuit 330 as its design (choice of components) becomes easier. This is because these circuits could otherwise have caused certain unwanted traps for band-mid and/or band-low.

Specifics that are most relevant for band-mid: Capacitor Cv1 and coils L4+L1 form a tune circuit and a matching circuit. FM-trap 380 can be switched ON using an FM-switch (with Vfm that is active low and then typically is set to 0.2V) to suppress incidental FM as required by FCC. Adding such an FM-trap in the prior art would have added >2 dB in NF. FM-trap 380 of the invention does not deteriorate the NF (Noise Figure). FM-trap 380 will be switched OFF using the FM-switch (with Vfm, active low, and then typically set to Vcc) when band-high or band-mid is used. An FM trap is a single fixed trap around 91 to 92 MHz that is usually ON in CH6 (picture 83.25 MHz and sound 87.75 MHz) to prevent FM signals in the lower fringe area of the FM region from creating visible interferences in this channel.

In the prior art, due to the size of the matching coil (L1 in FIG. 1 can be 400 nH), the FM-trap coil must also be big in order for the trap to work properly. Due to this, lower-frequency reception will generally suffer, e.g., due to a higher NF.

Coil L4 with varicap Cv1 forms a tuned ½ RF trap circuit 320 (which circuitry is actually also part of band-low). For band mid, the ½ RF trap circuit 320 is very important and, e.g., in a fully loaded cable system as it provides the system with a low noise figure band-low. For off-air and especially mobile, tuned ½ RF trap 320 for VHF 3 is providing a big benefit. The 2^{nd} harmonic (88X2 . . . 108X2) falls in the VHF 3 band for analog and digital. For cable, this suppression of the fundamental is important in unregulated cable situations (India, China, Taiwan, Argentina to name a few) where the signal strengths follow a square law K√f cable loss. The signal levels in the lower frequencies can be much higher than the higher frequencies. The frequency partition and the coil size in mid band are chosen to be approximately ½ the size (approximately in terms of value and size) in the mid band of the prior art. In the prior art, such a sized coil would have created a trap (self resonant) for band-high but due to the switching of the band-high switch to ON, this trap (actually its the self resonance) has become invisible for band-high. When a substantial same value varicap is used for varicap Cv1 and varicap Cv3, a tracking trap is formed. (the type of varicap does not necessarily need to be the same; different types can also be used with different effect) The improved noise figure is achieved because the relative large inductor of the prior art (e.g., L3 in FIG. 2.) is removed and replaced by a smaller one (L3 in FIG. 3). The damping resistor (R1 in FIG. 3) in this new arrangement is also approximate ½ the value of the prior art one to obtain the same bandwidth needed for TV.

Specifics that are most relevant for band-low: Capacitor Cv1 and coils L4+L1 form a tune circuit and a matching circuit. Due to their smaller values, coil L4 and coil L1 are about half the physical size as compared to coil L6 of FIG. 2 and coil L3 of FIG. 2. Therefore less space is required than compared to the prior art. This is a big advantage in order to miniaturize a tuner or front-end. When applying a low voltage at input voltage Vfm (active low Vfm is set to typically 0.2V) the FM trap is switched on, otherwise the FM trap is bypassed (active low Vfm is set to typically Vcc) using Capacitor Cinf1. This is advantageous for in a high quality TV receiver, as the trap is not required for many RF input signals. A switch-able FM trap, in combination with a ½ RF-trap, is especially useful at places where a strong FM transmitter signal interferes with, e.g., the VHF3 band (175-224 MHz). Such a signal disturbs analogue TV signals, e.g., such as in areas like Sao Paolo and Tokyo. But also in places where DVB-T is used, due to the large difference in the transmitter power (e.g., in Metro area, e.g., Megawatt FM transmitters exist in USA) between FM and DVB-T, the switch-able FM trap is very advantageous.

A UHF (high band) only tuner can be created by simply replacing Diode Du with a capacitor (e.g., Cu2). Also, a high and mid band capable tuner can be created by removing a part of the third RF resonant circuit 350 (low-band circuitry). This is important because typically in a digital Tuner application not all bands are used. Doing this does not affect the main performance of the other bands. TV input circuit 300 also yields an improved high band with respect to NF (Noise Figure) that is particularly important for mobile and other off-air applications.

RF input circuit 300 performs superior to the prior art; e.g., U.S. Pat. No. 4,851,796 suffers with noise problems, e.g., at the low end of the low band. Also U.S. Pat. No. 4,851,796 has some problems due to the CB trap in the UHF arm. In some shipped tuners, e.g., in China, the CB trap as described in U.S. Pat. No. 4,851,796 is removed just to improve the NF (Noise Figure). Also, CB rejection for mid band (CH E9) requires a high pass to get some buffer since the trap in UHF does not have a high enough Q.

A large matching coil in low band is disadvantageous (see, e.g., the Noise Figure of prior a art tuner) and due to self-resonance (UHF) problems it is impossible to make it small and/or flat in a prior art tuner without causing serious reception degradation in band-high.

RF input circuit 300 performs with a NF of maximum 6 (a typical NF can be as low as 5) in every channel incl. the band edges. Prior art tuners perform a couple of dB worse in NF.

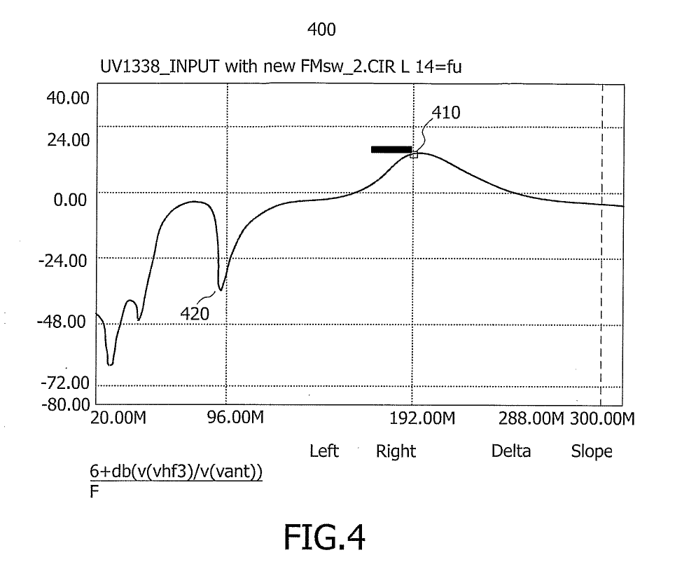

FIG. 4 shows an example of a frequency versus amplitude diagram 400 of a tuned ½ RF trap. In the diagram 400 the ½ RF trap is tuned such that the desired frequency F-wanted 410 is at 192 MHz and the trap frequency is located at approximately half of F-wanted 410 and that is F-unwanted 420 at 96 MHz. A tuned ½ RF trap is a filter that has a tuned trap and suppresses signals at half the desired frequency (typically a suppression of at least 40 dB is achieved compared to a signal at the desired frequency) and whereby the desired frequency can be tuned using is varicap. A same signal, typically V-tune, can be used to simultaneously tune the trap frequency and the desired frequency. In diagram 400, the ½ RF frequency is 192/2=96 MHz so signals at 96 MHz will be much suppressed, in this case a signal in the FM band. It is important to reject signals at half the desired frequency as much as possible as 2^{nd} order effects may well cause that signals located at half the desired frequency cause the desired signal to deteriorate.

One of ordinary skill in the art will recognize that alternative schemes of the circuitry can be devised to create a tuner circuitry with the advantages shown.

The foregoing merely illustrates the principles of the invention. It will thus be appreciated that those skilled in the art will be able to devise various arrangements which, although not explicitly described or shown herein, embody the principles of the invention and are thus within its spirit and scope.

1. A TV-RF input circuit comprising an RF coupling device via which an aerial input is coupled to first second and third parallel tunable RF resonant circuits for a parallel selection of a desired frequency in first, second and third TV frequency bands substantially succeeding one another in frequency, wherein
said first RF resonant circuit comprises a first RF resonance circuit inductance and wherein said RF coupling device having a first series inductance that can be magnetically coupled with the first RF resonance circuit inductance enabled by a switched capacitor using a band-high switch.

2. The TV-RF input circuit of claim 1, wherein said third RF resonant circuit includes a tuned ½ RF trap.

3. The TV-RF input circuit of claim 2, wherein the RF coupling device further comprises an FM trap and wherein the FM trap can be substantially bypassed by switching a capacitor by using an FM-switch.

4. A tuner comprising a TV-RF input circuit that includes an RF coupling device via which an aerial input is coupled to first, second and third parallel tunable RF resonant circuits for a parallel selection of a desired frequency in first, second and third TV frequency bands substantially succeeding one another in frequency, wherein
said first RF resonant circuit comprises a first RF resonance circuit inductance and wherein said RF coupling device having a first series inductance that can be magnetically coupled with the first RF resonance circuit inductance enabled by a switched capacitor using a band-high switch.

5. The tuner of claim 4, wherein said third RF resonant circuit includes a tuned ½ RF trap.

6. The tuner of claim 5, wherein the RF coupling device further comprises an FM trap and wherein the FM trap can be substantially bypassed by switching a capacitor by using an FM-switch.
